(19) United States
(12) Patent Application Publication
(10) Pub. No.: US 2006/0262676 A1
(43) Pub. Date: Nov. 23, 2006

(54) Optical disc apparatus and method of shifting layers in multi-layer optical disc

(75) Inventor: Moon-soo Han, Suwon-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/377,194

(22) Filed: Mar. 17, 2006

(30) Foreign Application Priority Data
May 17, 2005 (KR) 2005-41110

(51) Int. Cl. G11B 7/00

(52) U.S. Cl. 369/44.11

(57) ABSTRACT

A method of shifting layers in a multi-layer optical disc and an optical disc apparatus are provided. The method comprises applying a certain first drive voltage needed for a first layer shift when moving a focusing point in a multi-layer disc, calculating an upward deviation constant that is the length of a section where the FE (Focus Error) value is larger than a certain positive threshold value and a downward deviation constant that is the length of a section where the FE (Focus Error) value is smaller than a certain negative threshold value by detecting the characteristics of the FE (Focus Error) value change caused by a first drive voltage characteristic, determining a second drive voltage characteristic needed for a second layer shift using the upward deviation constant and the downward deviation constant, and applying a second drive voltage according to the second drive voltage characteristic. According the present invention, in an optical disc having a plurality of recording layers, a stable shift onto a target layer is allowed when shifting between layers in an optical disc, thereby effectively transferring information to users through a stable disc reproduction.

### CROSS-REFERENCE TO RELATED APPLICATIONS

This application claims all benefits accruing under 35 U.S.C. §119 from Korean Patent Application No. 2005-41110, filed on May 17, 2005, the content of which is incorporated by reference herein.

### BACKGROUND OF THE INVENTION

1. Field of the Invention

The present invention relates to an optical recording and reproduction and, more specifically, relates to a method of shifting layers in a multi-layer optical disc and an optical disc apparatus for performing the same.

2. Related Art

In general, an optical disc apparatus, such as a compact disc (CD) player, a digital versatile disc (DVD) player, a CD-ROM driver, and a DVD-ROM, is used to record/reproduce data on/from a recording medium, such as an optical disc. When an optical disc is provided with a dual-layer recording structure for high density data recording and subsequent data reproduction, an optical beam directed onto a surface of an optical disc must be shifted efficiently and seamlessly between different layers on the optical disc.

FIG. 1 shows a typical optical disc having a dual-layer recording structure. As shown in FIG. 1, the optical disc is a digital versatile disc (DVD) having a dual-layer recording structure in which a zero-th recording layer (layer 0) 10 and a first recording layer (layer 1) 20 are formed to record data.

FIG. 2 shows an S-curve in a focus search of a typical optical disc apparatus. Referring to FIG. 2, if an optical pickup lens 30 is swung, while power is applied to an optical source, typically a laser diode (LD) inside an optical pickup unit (not shown), focus error values form an S-curve 50 around a recording layer 40. That is, when a focus search is performed in an optical disc apparatus, an S-curve occurs per one recording layer. Here, the zero cross point 60 (the point where the FE (Focus Error) value is ‘0’) of an S-curve is a focus lead-in point that is the focusing point of a corresponding recording layer.

The S-curve described above occurs one per each recording layer in a case of an optical disc having a dual-layer recording structure, as shown in FIG. 1. That is, one S-curve occurs at each of the zero-th recording layer (layer #0) 10 and the first recording layer (layer #1) 20, shown in FIG. 1, respectively. Accordingly, in the case of shifting between recording layers 10 and 20, an S-curve occurs at each recording layer 10 and 20 in an optical disc having a dual-layer recording structure.

FIG. 3 shows a conventional method of shifting layers in an optical disc having a dual-layer recording structure. Referring to FIGS. 2 and 3, in order to shift between layers on an optical disc, such as a DVD, from an optical pickup lens 30 location toward the optical disc (upward shift), if a certain drive voltage 70 is applied to a focus actuator driver (FOD) (not shown) that controls the upward and downward movements of the pickup lens 30, the pickup lens 30 deviates the focusing point of layer #0, and an S-curve corresponding to recording layer #1 occurs thereafter.

At this point, if a point corresponding to recording layer #1 is detected on the S-curve, a brake voltage 80 is applied for a smooth shift onto recording layer #1, and if a zero cross point on the S-curve of recording layer #1 is detected, a focus servo is turned on, and the shift operation onto recording layer #1 is completed.

That is, in the conventional method of shifting layers in an optical disc having a dual-layer recording structure as described above, the FOD adopts the Kick-and-Brake method for shifting layers. However, if an optical disc has a three-or-more-layer recording structure, applying a drive voltage and a brake voltage once for all for shifting layers cannot assure a smooth shift between layers on an optical disc.

In a case where the layers on an optical disc to be shifted are two or more, a smooth layer shift onto a target layer cannot be assured by applying a drive voltage only once. In addition, in a case where a displacement occurs in the focal direction of an optical disc, a correct shift onto a target layer on such an optical disc cannot be assured.

### SUMMARY OF THE INVENTION

Various aspects and example embodiment of the present invention advantageously provide a more efficient method of shifting layers in a multi-layer optical disc and an optical disc apparatus for performing the same.

Additional aspects and/or advantages of the invention will be set forth in part in the description which follows and, in part, will be obvious from the description, or may be learned by practice of the invention.

In accordance with an aspect of the present invention, there is provided a method of shifting layers in a multi-layer optical disc. Such a method comprises: applying a first drive voltage needed for a first layer shift to a pickup unit when moving a focusing point in a multi-layer disc; calculating an upward deviation constant that is the length of a section where a focus error (FE) value is larger than a certain positive threshold value and a downward deviation constant that is the length of a section where the FE value is smaller than a certain negative threshold value by detecting the characteristics of the FE value change caused by a first drive voltage characteristic; determining a second drive voltage characteristic needed for a second layer shift using the upward deviation constant and the downward deviation constant; and applying a second drive voltage to the pickup unit according to the second drive voltage characteristic.

Preferably, the method of shifting layers further comprises applying a certain brake voltage in order to complete layer shifting, when the FE value caused by the second drive voltage characteristic arrives at a certain limit value. In addition, a compensation value is used to determine the second drive voltage characteristic, wherein the compensation value is calculated such that the downward deviation constant is subtracted from the upward deviation constant, and then the result is multiplied by a certain proportional constant.

In addition, in a case where the layer shift is an upward shift, the magnitude of the second drive voltage is determined by adding the compensation value to the magnitude of the first drive voltage. Conversely, in a case where the layer shift is a downward shift, the magnitude of the second drive voltage is determined by subtracting the compensation value from the magnitude of the first drive voltage.

In addition, in a case where the layer shift is an upward shift, the time period for applying the second drive voltage is determined by adding the compensation value to the time period for applying the first drive voltage. Conversely, in a case where the layer shift is a downward shift, the time period for applying the second drive voltage is determined by subtracting the compensation value from the time period for applying the first drive voltage.

In addition, the proportional constant is determined by either a magnitude relation between the upward deviation constant and the downward deviation constant, or the shift direction of the layer. Alternatively, the proportional constant can be determined by a user's setting.

An upward deviation constant and a downward deviation constant are calculated by detecting the characteristics of the FE value change caused by the first drive voltage characteristic, determining a second drive voltage characteristic needed for a second layer shift using the upward deviation constant and the downward deviation constant, and applying a second drive voltage according to the second drive voltage characteristic are consecutively performed according to the increase in the number of the layers required to be shifted.

In addition, the first drive voltage and the second drive voltage are applied when the FE (Focus Error) value is ‘0’.

In accordance with another aspect of the present invention, an optical disc apparatus is provided with an optical pickup unit provided with a first drive voltage needed for a first layer shift and a second drive voltage needed for a second layer shift when moving a focusing point in a multi-layer disc; an RF unit for receiving a reflection signal from the pickup unit and outputting an FE (Focus Error) value; and a servo unit for applying the first drive voltage to the pickup unit, calculating an upward deviation constant that is the length of a section where the FE value is larger than a certain positive threshold value and a downward deviation constant that is the length of a section where the FE value is smaller than a certain negative threshold value by detecting the characteristics of the FE value change caused by the first drive voltage characteristic, determining a second drive voltage characteristic needed for the second layer shift using the upward deviation constant and the downward deviation constant, and applying the second drive voltage to the pickup unit according to the second drive voltage characteristic.

Preferably, the servo unit applies a certain brake voltage to the pickup unit in order to complete layer shifting, when the FE value caused by the second drive voltage characteristic arrives at a certain limit value. In addition, a compensation value is used in determining the second drive voltage characteristic, wherein the compensation value is calculated such that the downward deviation constant is subtracted from the upward deviation constant, and then the result is multiplied by a certain proportional constant.

In addition, in a case where the layer shift is an upward shift, the magnitude of the second drive voltage is determined by adding the compensation value to the magnitude of the first drive voltage. Conversely, in a case where the layer shift is a downward shift, the magnitude of the second drive voltage is determined by subtracting the compensation value from the magnitude of the first drive voltage.

In addition, in a case where the layer shift is an upward shift, the time period for applying the second drive voltage is determined by adding the compensation value to the time period for applying the first drive voltage. Conversely, in a case where the layer shift is a downward shift, the time period for applying the second drive voltage is determined by subtracting the compensation value from the time period for applying the first drive voltage.

In addition, the proportional constant is determined by either a magnitude relation between the upward deviation constant and the downward deviation constant, or the shift direction of the layer. Alternatively, the proportional constant can be determined by a user's setting.

In addition, the servo unit consecutively performs, according to the increase in the number of the layers required to be shifted, the operations of applying the first drive voltage to the pickup unit according to a first drive voltage characteristic needed for the first layer shift, calculating an upward deviation constant and a downward deviation constant by detecting the characteristics of the FE value change caused by the first drive voltage characteristic received from the RF unit, determining a second drive voltage characteristic needed for the second layer shift using the upward deviation constant and the downward deviation constant, and applying the second drive voltage to the pickup unit according to the second drive voltage characteristic.

In addition, the first drive voltage and the second drive voltage are applied when the FE (Focus Error) value is ‘0’. In addition, the optical recorder may further comprise a micro computer for transferring a layer shift command to the servo unit.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates a typical optical disc having a dual-layer recording structure;

FIG. 2 illustrates an S-curve in a focus search of a typical optical disc apparatus;

FIG. 3 illustrates a typical method of shifting layers in an optical disc having a dual-layer recording structure;

FIG. 4 illustrates a configuration of an example optical disc apparatus according to an embodiment of the present invention;

FIG. 5 illustrates a method of shifting layers in an optical disc having a multi-layer recording structure according to an embodiment of the present invention; and

FIG. 6 is a flowchart of a method of shifting layers in an optical disc having a multi-layer recording structure according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 4 shows a configuration of an example optical disc apparatus according to an embodiment of the present invention. In accordance with an example embodiment of the present invention, an optical disc having a multi-layer recording structure can be any member of a digital versatile disk (DVD) family, including DVD-R, DVD-RW, DVD+RW, DVD-RAM, DVD-ROM, or a compact disc (CD) family, including, CD-R, CD-RW, and CD-ROM. In addition, such an optical disc can also be any high-density medium, such as a blue-ray disc (BD), a high density DVD (HD DVD) and an advanced optical disc (AOD). Likewise, the optical disc apparatus as shown in FIG. 4, can be a single recording device or multiple devices for data recording and data reproduction incorporated therein, including, for example, a CD recorder, a DVD recorder used to record data on an optical disc and to reproduce data recorded on the optical disc.

As shown in FIG. 4, the optical disc apparatus according to an embodiment of the present invention comprises a micro computer 100, a servo unit 130, an optical pickup unit 160, and an RF unit 190. Here, the micro computer 100 transmits a layer shift command to the servo unit 130 through an external input signal.

The servo unit 130 applies a drive voltage and a brake voltage to the optical pickup unit 160, which are needed to shift between layers in an optical disc (not shown), and detects an FE (Focus Error) value from the RF unit 190. In the optical pickup unit 160, an optical pickup lens (not shown) moves up and downwardly in response to the drive voltage applied from the servo unit 130, and, thus, the reflection signal from an optical receiver DD (not shown) is transferred to the RF unit 190.

The RF unit 190 calculates the FE value through the reflection signal received from the optical pickup unit 160, and transmits the FE value to the servo unit 130.

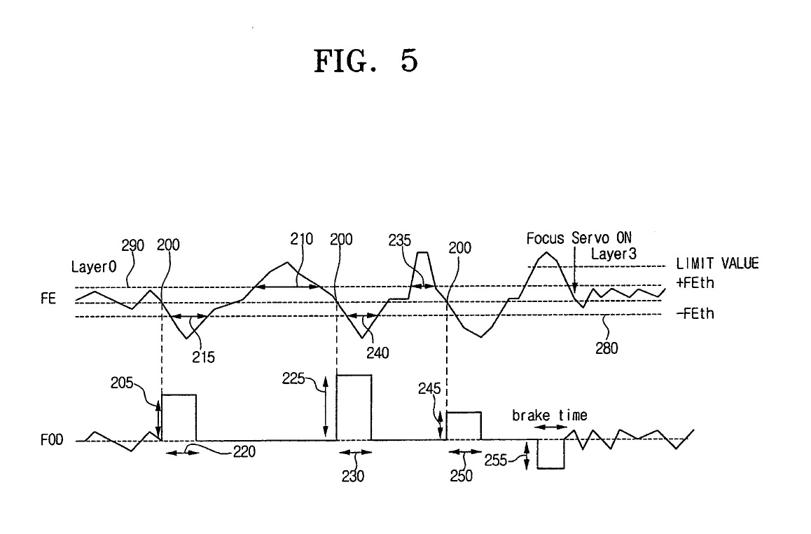

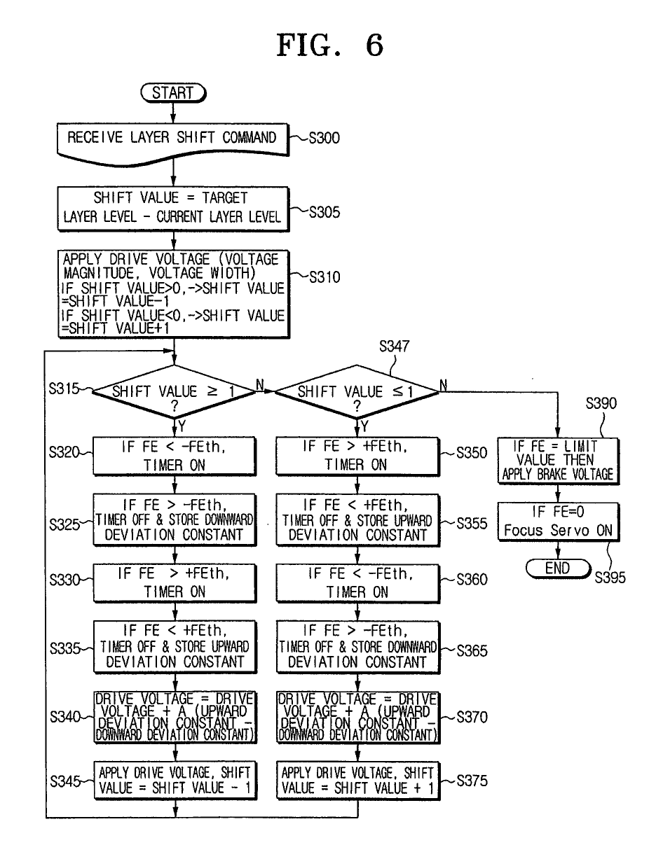

FIG. 5 shows a method of shifting layers in a multi-layer optical disc according to an embodiment of the present invention. Referring to FIGS. 4 and 5, a method of shifting layers in a multi-layer optical disc according to an embodiment of the present invention is explained as follows.

First, an example optical disc is provided with four recording layers. However, such an optical disc can also have different multiple recording layers. The four recording layers of the optical disc as described with reference to FIGS. 4 and 5, are called layer #0, layer #1, layer #2, and layer #3 respectively from the surface of the optical disc. Hereafter, an operating principle of the present invention is described in the case of shifting upwardly from layer #0 to layer #3. FIG. 5 shows characteristics of the FE value change when shifting layers from layer #0 to layer #3.

First, when the servo unit 130 of an optical disc apparatus, as shown in FIG. 4, receives an upward shift command for shifting layers on an optical disc from layer #0 to layer #3 from the micro computer 100, the servo unit 130 detects the change of a focus error (FE) value from the RF unit 190. If the waveform showing the change of the FE value crosses a zero cross point 200, as shown in FIG. 5, the servo unit 130 applies a first drive voltage needed to shift layers from layer #0 to layer #1 to the pickup unit 160. Here, the first drive voltage has a certain magnitude 205 and width 220.

According to first drive voltage, the pickup lens (not shown) of the pickup unit 160 moves upwardly. As a result, the optical receiver (not shown) of the pickup unit 160 transmits a reflection signal to the RF unit 190, and the RF unit 190 transmits the change of the FE value to the servo unit 130 through the reflection signal.

The servo unit 130 measures the time taken from the point where the FE value becomes larger than a certain positive threshold value 290 to the point where the FE value becomes again smaller than the certain positive threshold value 290. The measured time value is referred to as a first upward deviation constant 210.

The servo unit 130 measures the time taken from the point where the FE value becomes smaller than a certain negative threshold value 280 to the point where the FE value becomes again larger than the certain negative threshold value 280. The measured time value is referred to as a first downward deviation constant 215.

If the pickup lens (not shown) of the pickup unit 160 moves upwardly at a uniform speed, the first upward deviation constant 210 and the first downward deviation constant 215 are almost the same. However, the case where the first upward deviation constant 210 is larger than the first downward deviation constant 215 represents a situation where the pickup lens (not shown) of the pickup unit 160 has a strong upward force. In contrast, the case where the first upward deviation constant 210 is smaller than the first downward deviation constant 215 represents a situation where the pickup lens (not shown) of the pickup unit 160 has a weak upward force.

Therefore, the servo unit 130 can control the magnitude of the drive voltage to be applied to the pickup unit 160 by comparing the magnitudes of the first upward deviation constant 210 and the first downward deviation constant 215, when shifting between layers, for example, from layer #1 to layer #2, i.e., the next shifting step.

That is, in a case where the pickup lens (not shown) of the pickup unit 160 has a strong upward force, when the drive voltage is applied in the next shifting step, the magnitude needs to be controlled so as to be a little small. In contrast, in a case where the pickup lens (not shown) of the pickup unit 160 has a weak upward force, when the drive voltage is applied in the next shifting step, the magnitude needs to be controlled so as to be a little large.

Here, the method of controlling the magnitude of the drive voltage so as to be a little small or large can be implemented in such a way that a compensation value is added to the magnitude 205 of the first drive voltage. The compensation value can be calculated such that the first downward deviation constant 215 is subtracted from the first upward deviation constant 210 (this value will be a negative value in the case where the upward force is strong, and a positive value in the case where the upward force is weak), and then the result is multiplied by a predetermined proportional constant.

At this point, the predetermined proportional constant as described above must be a positive value. Such a constant can be separately set according to whether the drive voltage is controlled to be a slightly large or slightly small, and/or can be determined by a user's setting.

In addition, in the case where the upward force is strong, although the magnitude of the drive voltage can be controlled to be a slightly small, the time during which the drive voltage is applied can also be decreased slightly. In the case where the upward force is weak, although the magnitude of the drive voltage can be controlled to be a slightly large, the time during which the drive voltage is applied can also be increased slightly.

That is, the method of decreasing or increasing the time period for applying the drive voltage can be implemented in such a way that a compensation value is added to the time period 220 for applying the first drive voltage. Such a compensation value can be calculated such that the first downward deviation constant 215 is subtracted from the first upward deviation constant 210 as described above (this value will be a positive value in the case where the upward force is strong, and a negative value in the case where the upward force is weak), and then the result is multiplied by a predetermined proportional constant.

Here, the predetermined proportional constant can also be separately set according to whether the drive voltage is controlled to be a slightly large or small, and/or can be determined by a user's setting

In addition, although a case of shifting between layers upwardly is explained as an example, when using an optical disc apparatus shown in FIG. 4, layers on an optical disc can be shifted downwardly as well. In this case, the magnitude of the second drive voltage is determined by subtracting the compensation value from the first drive voltage as described above.

In addition, in the case of a downward layer shift, the time period for applying the second drive voltage can be determined by subtracting the compensation value described above from the time period for applying the first drive voltage described above.

According to FIG. 5, the upward force of the pickup lens (not shown) of the pickup unit 160 controlled by the first drive voltage is weak, so that it can be confirmed that the magnitude 225 of the second drive voltage has become larger than the magnitude 205 of the first drive voltage by the compensation value as described above.

Next, the servo unit 130 applies the second drive voltage to the pickup unit 160, and detects the change of the FE value caused by the second drive voltage from the RF unit 190.

If the waveform showing the change of the FE value crosses again the zero cross point 200, the second drive voltage needed to shift layers, from layer #1 to layer #2 in an optical disc, is applied to the pickup unit 160. Here, the second drive voltage has the characteristics of a certain magnitude 225 and width 230 compensated by the compensation value described above.

Accordingly, the pickup lens (not shown) of the pickup unit 160 moves again upwardly. As a result, the optical receiver (not shown) of the pickup unit 160 transmits a reflection signal to the RF unit 190, and the RF unit 190 transmits the change of the FE value to the servo unit 130 through the reflection signal.

The servo unit 130 measures the time taken from the point where the FE value becomes larger than a certain positive threshold value 290 to the point where the FE value becomes again smaller than the certain positive threshold value 290. The measured time value is referred to as a second upward deviation constant 235.

The servo unit 130 measures the time taken from the point where the FE value becomes smaller than a certain negative threshold value 280 to the point where the FE value becomes again larger than the certain negative threshold value 280. The measured time value is referred to as a second downward deviation constant 240.

Also here, if the pickup lens (not shown) of the pickup unit 160 moves upwardly at a uniform speed, the second upward deviation constant 235 and the second downward deviation constant 240, as shown in FIG. 5, are almost the same. However, the case where the second upward deviation constant 235 is larger than the second downward deviation constant 240 is a case where the pickup lens (not shown) of the pickup unit 160 has a strong upward force. Conversely, the case where the second upward deviation constant 235 is smaller than the second downward deviation constant 240 is a case where the pickup lens (not shown) of the pickup unit 160 has a weak upward force.

In addition, the characteristics (the magnitude of a voltage and the time period for applying a voltage) 245 and 250 of a third drive voltage needed to shift layers upwardly from layer #2 to layer #3 in an optical disc can be calculated by adding a compensation value, wherein the compensation value is calculated such that the second downward deviation constant 240 is subtracted from the second upward deviation constant 235, and then the result is multiplied by a predetermined proportional constant. Such a constant may be determined based on whether the relative difference between the upward deviation constant and the downward deviation constant or by the direction in which the layer is shifting. More specifically, if the upward deviation constant is larger than the downward deviation constant, the value obtained by subtracting the first downward deviation constant from the first upward deviation constant would be a positive (+) value; and if the upward deviation constant is smaller than the downward deviation constant, the value obtained by subtracting the first downward deviation constant from the first upward deviation constant would be a negative (−) value. The constant is a positive (+) value, and is set to a value smaller than a certain value if the upward deviation constant is larger than the downward deviation constant, and is set to a value larger than the certain value if the upward deviation constant is smaller than the downward deviation constant. The compensation value is calculated by multiplying the value obtained by subtracting the first downward deviation constant from the first upward deviation constant by a predetermined proportional constant which is set based on whether the upward deviation constant or the downward deviation constant is larger.

According to FIG. 5, the upward force of the pickup lens (not shown) of the pickup unit 160 controlled by the second drive voltage is weak, so that it can be confirmed that the magnitude 245 of the third drive voltage has become smaller than the magnitude 225 of the second drive voltage by the compensation value as described above.

Next, the servo unit 130 applies the third drive voltage to the pickup unit 160, and detects the change of the FE value caused by the third drive voltage from the RF unit 190.

If the waveform showing the change of the FE value crosses again the zero cross point 200, the servo unit 130 applies the third drive voltage needed to shift layers from layer #2 to layer #3 in an optical disc to the pickup unit 160. Here, the third drive voltage has the characteristics of a certain magnitude 245 and width 250 compensated by the compensation value described above.

Accordingly, the pickup lens (not shown) of the pickup unit 160 moves again upwardly. As a result, the optical receiver (not shown) of the pickup unit 160 transmits a reflection signal to the RF unit 190, and the RF unit 190 transmits the change of the FE value to the servo unit 130 through the reflection signal.

Here, when the FE (Focus Error) value arrives at a certain limit value, the servo unit 130 applies a certain brake voltage 255 to the pickup unit 160 in order to complete layer shifting in an optical disc. As a result, the shift onto layer #3, i.e. the target layer, is accomplished. Next, if the FE value crosses the zero cross point, the servo unit 130 turns on the focus servo, and the record on the shifted layer is reproduced through output signals.

FIG. 6 is a flowchart showing a method of shifting layers in a multi-layer optical disc according to an embodiment of the present invention.

Referring to FIG. 6, the micro computer 100 transmits a layer shift command to the servo unit 130 at block S300. Next, the servo unit 130 calculates a shift value, i.e. a value calculated by subtracting the current layer level from the target layer level at block S305.

Next, the servo unit 130 applies a certain drive voltage to the pickup unit 160. If the shift value described above is a positive value, the shift value is defined by subtracting ‘1’ from the shift value. Conversely, if the shift value is a negative value, the shift value is defined by adding “1” to the shift value at block S310.

If the current layer level on an optical disc is layer #0, and the target layer level is layer #3, the shift value obtained at block S305 is ‘3’, and the shift value obtained at block S310 is ‘2’.

Next, the servo unit 130 confirms whether the shift value is larger than or equal to ‘1’ at block S315. If the shift value is larger than or equal to ‘1’, the servo unit 130 measures the time taken from the point where the FE value becomes smaller than a certain negative threshold value to the point where the FE value becomes again larger than the certain negative threshold value, and stores the measured time value as a downward deviation constant at block S320, and block S325.

In addition, the servo unit 130 measures the time taken from the point where the FE value becomes larger than a certain positive threshold value to the point where the FE value becomes smaller than the positive threshold value, and stores the measured time value as an upward deviation constant at block S330, and block S335.

Next, the servo unit 130 adds a certain compensation value to the previously applied drive voltage, and the resulting value is redefined as the drive voltage at block S340. The compensation value is calculated such that the downward deviation constant is subtracted from the upward deviation constant, and then the result is multiplied by a predetermined proportional constant. The servo unit 130 applies the drive voltage redefined at block S340 to the pickup unit 160, and, at this point, the shift value decreases again by ‘1’ at block S345.

In a case where the decreased shift value is still larger than or equal to ‘1’, blocks S320 to S345 are repeated. In the case where the shift value is judged as ‘0’ as a result of the iteration, the servo unit 130 applies a certain brake voltage when the FE value arrives at a certain limit value, and attempts layer shifting onto the target layer in an optical disc at block S390.

Next, at the point where the FE value crosses the zero cross point, the servo unit 130 turns on the focus servo at block S395.

Again, in the case where the shift value is smaller than or equal to ‘−1’ at block S347, the servo unit 130 measures the time taken from the point where the FE value becomes larger than a certain positive threshold value to the point where the FE value becomes smaller than the certain positive threshold value described above, and stores the measured time value as an upward deviation constant at block S350, and block S355.

In addition, the servo unit 130 measures the time taken from the point where the FE value becomes smaller than a certain negative threshold value to the point where the FE value becomes larger than the certain negative threshold value described above, and stores the measured time value as a downward deviation constant at block S360, and block S365.

Next, the servo unit 130 adds a certain compensation value to the previously applied drive voltage, and the resulting value is redefined as the drive voltage at block S370. The compensation value is calculated such that the downward deviation constant is subtracted from the upward deviation constant, and then the result is multiplied by a predetermined proportional constant. The servo unit 130 applies the drive voltage redefined at block S370 to the pickup unit 160, and, at this point, the shift value increases again by ‘1’ at block S375.

In a case where the increased shift value is still smaller than or equal to ‘−1’, blocks S350 to S375 are repeated. In the case where the shift value is judged as ‘0’ as a result of the iteration, the servo unit 130 applies a certain brake voltage when the FE value arrives at a certain limit value, and attempts layer shifting onto the target layer in an optical disc at block S390.

Next, at the point where the FE value crosses the zero cross point, the servo unit 130 turns on the focus servo at block S395.

As described above, according the present invention, in a multi-layer optical disc having a plurality of recording layers, a stable shift onto a target layer is advantageously obtained when shifting layers, thereby effectively transferring information to users through a stable disc reproduction.

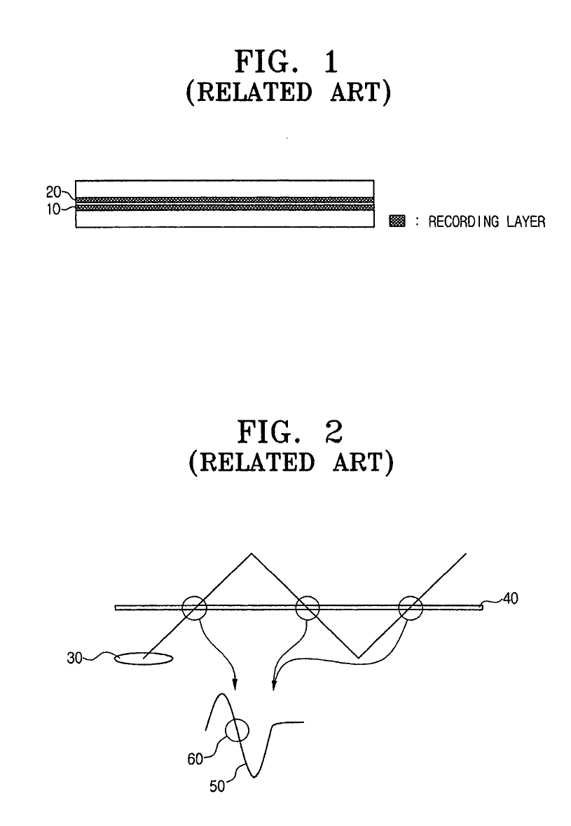

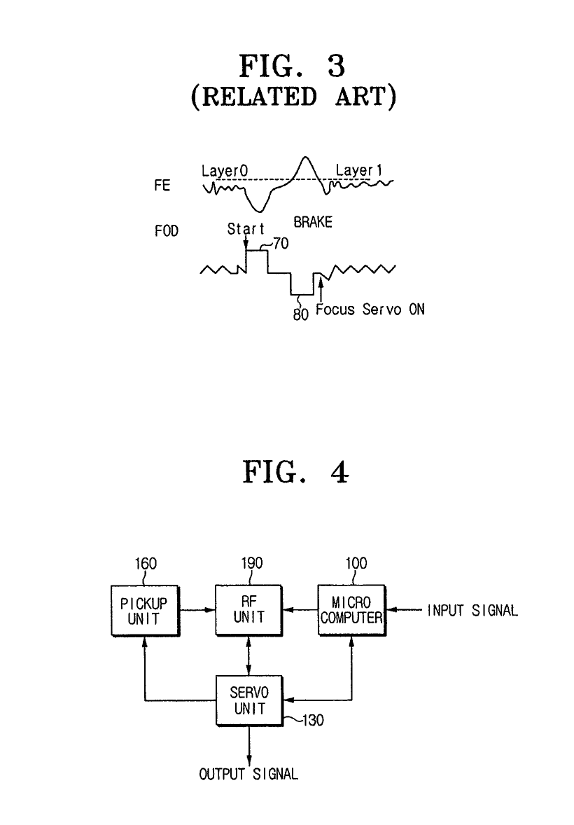

Although the preferred embodiment of the present invention has been described, it will be understood by those skilled in the art that the present invention should not be limited to the described preferred embodiment, but various changes and modifications can be made within the spirit and scope of the present invention. For example, components of an optical disc apparatus, as shown in FIG. 1, can be arranged differently, or integrated therein, as long as techniques of shifting between layers in an optical disc having a plurality of recording layers are utilized in the manner as described with reference to FIG. 5 and FIG. 6. Similarly, existing components of the optical disc apparatus can be implemented as a chipset having firmware, or alternatively, a general or special purposed computer programmed to implement techniques as described with reference to FIG. 5 and FIG. 6. Accordingly, it is intended, therefore, that the present invention not be limited to the various example embodiments disclosed, but that the present invention includes all embodiments falling within the scope of the appended claims.

What is claimed is:

1. A method of shifting layers in a multi-layer disc, comprising:
applying a first drive voltage to an optical pickup unit needed for a first layer shift, when moving a focusing point in a multi-layer disc;
calculating an upward deviation constant and a downward deviation constant based on characteristics of a focus error (FE) value change caused by the first drive voltage, the upward deviation constant representing a length of a section where an FE (Focus Error) value is larger than a certain positive threshold value, and the downward deviation constant representing a length of a section where an FE (Focus Error) value is smaller than a certain negative threshold value;
determining a second drive voltage needed for a second layer shift using the upward deviation constant and the downward deviation constant; and
applying the second drive voltage to the optical pickup unit to perform the second layer shift in the multi-layer disc.

2. The method as claimed in claim 1, further comprising applying a certain brake voltage in order to complete layer shifting, when the FE value caused by the second drive voltage arrives at a certain limit value.

3. The method as claimed in claim 1, wherein a compensation value is used to determine the second drive voltage, the compensation value being calculated such that the downward deviation constant is subtracted from the upward deviation constant, and then a result is multiplied by a predetermined proportional constant.

4. The method as claimed in claim 3, wherein, in a case where a layer shift is an upward shift, a magnitude of the second drive voltage is determined by adding the compensation value to a magnitude of the first drive voltage, and in a case where the layer shift is a downward shift, the magnitude of the second drive voltage is determined by subtracting the compensation value from the magnitude of the first drive voltage.

5. The method as claimed in claim 3, wherein, in a case where a layer shift is an upward shift, a time period for applying the second drive voltage is determined by adding the compensation value to a time period for applying the first drive voltage, and in a case where the layer shift is a downward shift, the time period for applying the second drive voltage is determined by subtracting the compensation value from the time period for applying the first drive voltage.

6. The method as claimed in claim 3, wherein the proportional constant is determined by either a magnitude relation between the upward deviation constant and the downward deviation constant, or a shift direction of the layer.

7. The method as claimed in claim 6, wherein the proportional constant is determined by a user's setting.

8. The method as claimed in claim 1, wherein the upward deviation constant and the downward deviation constant are calculated by detecting characteristics of the FE value change caused by the first drive voltage; determining the second drive voltage needed for a second layer shift using the upward deviation constant and the downward deviation constant; and applying the second drive voltage to the optical pickup unit are consecutively performed according to an increase in number of the layers required to be shifted in the multi-layer disc.

9. The method as claimed in claim 1, wherein the first drive voltage and the second drive voltage are applied when the FE value is ‘0’.

10. An optical disc apparatus comprising:
a pickup unit provided with a first drive voltage needed for a first layer shift and a second drive voltage needed for a second layer shift, when moving a focusing point in a multi-layer disc;
an RF unit arranged to receive a reflection signal from the pickup unit and output an FE (Focus Error) value; and
a servo unit for applying the first drive voltage to the pickup unit, calculating an upward deviation constant that is a length of a section where the FE value is larger than a certain positive threshold value and a downward deviation constant that is a length of a section where the FE value is smaller than a certain negative threshold value by detecting characteristics of an FE value change caused by a first drive voltage, determining a second drive voltage needed for the second layer shift using the upward deviation constant and the downward deviation constant, and applying the second drive voltage to the pickup unit.

11. The optical disc apparatus as claimed in claim 10, wherein the servo unit applies a certain brake voltage to the pickup unit in order to complete layer shifting, when the FE value caused by the second drive voltage arrives at a certain limit value.

12. The optical disc apparatus as claimed in claim 11, wherein a compensation value is used to determine the second drive voltage, and is calculated such that the downward deviation constant is subtracted from the upward deviation constant, and then a result is multiplied by a predetermined proportional constant.

13. The optical disc apparatus as claimed in claim 12, wherein, in a case where a layer shift is an upward shift, a magnitude of the second drive voltage is determined by adding the compensation value to a magnitude of the first drive voltage, and in a case where the layer shift is a downward shift, the magnitude of the second drive voltage is determined by subtracting the compensation value from the magnitude of the first drive voltage.

14. The optical disc apparatus as claimed in claim 12, wherein, in a case where a layer shift is an upward shift, a time period for applying the second drive voltage is determined by adding the compensation value to a time period for applying the first drive voltage, and in a case where the layer shift is a downward shift, the time period for applying the second drive voltage is determined by subtracting the compensation value from the time period for applying the first drive voltage.

15. The optical disc apparatus as claimed in claim 12, wherein the proportional constant is determined by either a magnitude relation between the upward deviation constant and the downward deviation constant, or a shift direction of the layer.

16. The optical disc apparatus as claimed in claim 15, wherein the proportional constant is determined by a user's setting.

17. The optical disc apparatus as claimed in claim 10, wherein the servo unit consecutively performs, according to an increase in number of the layers required to be shifted, operations of applying the first drive voltage to the pickup unit according to the first drive voltage needed for the first layer shift, calculating an upward deviation constant and a downward deviation constant by detecting characteristics of the FE value change caused by the first drive voltage received from the RF unit, determining the second drive voltage needed for the second layer shift using the upward deviation constant and the downward deviation constant, and applying the second drive voltage to the pickup unit.

18. The optical disc apparatus as claimed in claim 10, wherein the first drive voltage and the second drive voltage are applied when the FE value is ‘0’.

19. The optical disc apparatus as claimed in claim 10, further comprising a micro computer for transferring a layer shift command to the servo unit.

20. An optical disc apparatus comprising:
an optical pickup unit arranged to move a focusing point between layers in an optical disc having a plurality of recording layers;
an RF unit arranged to receive a reflection signal from the pickup unit and output a focus error (FE) value; and
a servo unit arranged to apply a first drive voltage to the optical pickup unit needed for a first layer shift, to calculate an upward deviation constant that is a length of a section where the FE value is larger than a certain positive threshold value and a downward deviation constant that is a length of a section where the FE value is smaller than a certain negative threshold value, based on characteristics of an FE value change caused by a first drive voltage, to determine a second drive voltage to the optical pickup unit needed for a second layer shift using the upward deviation constant and the downward deviation constant, and to applying the second drive voltage to the optical pickup unit.

21. The optical disc apparatus as claimed in claim 20, wherein the servo unit applies a certain brake voltage to the pickup unit in order to complete layer shifting, when the FE value caused by the second drive voltage arrives at a certain limit value.

22. The optical disc apparatus as claimed in claim 21, wherein a compensation value is used in determining the second drive voltage, and is calculated such that the downward deviation constant is subtracted from the upward deviation constant, and then a result is multiplied by a predetermined proportional constant.

23. The optical disc apparatus as claimed in claim 22, wherein, in a case where a layer shift is an upward shift, a magnitude of the second drive voltage is determined by adding the compensation value to a magnitude of the first drive voltage, and in a case where the layer shift is a downward shift, the magnitude of the second drive voltage is determined by subtracting the compensation value from the magnitude of the first drive voltage.

24. The optical disc apparatus as claimed in claim 22, wherein, in a case where a layer shift is an upward shift, a time period for applying the second drive voltage is determined by adding the compensation value to a time period for applying the first drive voltage, and in a case where the layer shift is a downward shift, the time period for applying the second drive voltage is determined by subtracting the compensation value from the time period for applying the first drive voltage.

25. The optical disc apparatus as claimed in claim 22, wherein the proportional constant is determined by either a magnitude relation between the upward deviation constant and the downward deviation constant, or a shift direction of the layer.

26. The optical disc apparatus as claimed in claim 20, further comprising a micro computer for transferring a layer shift command to the servo unit.
